(19) United States
(12) Patent Application Publication
(10) Pub. No.: US 2008/0107698 A1
(43) Pub. Date: May 8, 2008

(54) Antimicrobial Cellulosic Sheet

(75) Inventors: Phuong V. Luu, Appleton, WI (US); Kang Chang Yeh, Neenah, WI (US)

Correspondence Address: PATENT GROUP GA030-43;GEORGIA-PACIFIC LLC, 133 PEACHTREE STREET, N.E., ATLANTA, GA, 30303-1847, US

(73) Assignee: FORT JAMES CORPORATION, Atlanta, GA (US)

(21) Appl. No.: 11/557,782

(22) Filed: Nov. 8, 2006

(51) Int. Cl. A01N 25/34; A01P 1/00; A01N 25/00; A01N 31/14

(52) U.S. Cl. 424/404; 514/721; 514/772; 514/785; 514/784

(57) ABSTRACT

A cellulosic sheet for paper towel includes an anti-microbial lotion on the towel which increases water absorbency times (WAR) to further promote lotion transfer to the skin and increase lotion transfer effectiveness.

### CLAIM FOR PRIORITY

This non-provisional application is based upon U.S. Provisional Patent Application Ser. No. 60/748,499, of the same title, filed Dec. 8, 2005. The priority of U.S. Provisional Patent Application Ser. No. 60/748,499 is hereby claimed and the disclosure thereof is incorporated into this application by reference.

### TECHNICAL FIELD

The present invention relates to paper towels used as hand towels. An anti-microbial lotion on the towel increases water absorbency times (WAR) to further promote lotion transfer to the skin and increase transfer effectiveness. Most preferably, lotion is applied as a micro-emulsion.

### BACKGROUND

Frequent hand washing is a simple and effective means to ensure proper hygiene and prevent contamination of food and the spread of disease. Complex systems have been proposed to encourage food service and health care workers to adequately cleanse their hands frequently, in view of the relatively high potential for undesirable contamination associated with their activities.

Washing of the skin, especially the hands, with antimicrobial soap formulations can remove many viruses and bacteria from the washed surfaces. Removal of the viruses and bacteria is due to the surfactancy of the soap and the mechanical action of the wash procedure. Therefore, it is known and recommended that the people wash frequently to reduce the spread of viruses and bacteria. Recent surveys, however, have revealed that while nearly 95% of people claim to have washed their hands after use of public restrooms, actual observations reveal that this figure does not exceed about 66%. Notwithstanding increased awareness, there is a tendency to rush the hand washing process which leads to inadequate hygiene. A number systems and devices to encourage longer and more thorough handwashing have accordingly been developed.

Collopy in U.S. Pat. No. 6,832,916 discloses a hand-washing device containing a display panel that encourages the user to wash their hands for about 15 seconds to remove germs. Gorra, U.S. Pat. No. 5,945,910 discloses method and apparatus for monitoring and reporting hand washing, which includes a sensor for signaling the dispensation of a cleaning agent from a dispenser, and a reporting and monitoring module. Allen et al., U.S. Pat. No. 5,781,942 discloses wash stations and method of operation, which monitors hand washing and assists in hand washing. These systems are relatively expensive and difficult to implement; oftentimes involving training and monitoring personnel. Even when such steps have been taken, there is little certainty that all personnel have followed proper washing procedures.

Frequent hand washing has the drawback that harsh soaps and cleansing agents can irritate the skin and damage the acid mantle of the skin.

Cellulosic substrates coated with lotions are well known in the art. For example, U.S. Pat. No. 5,665,426 to Krzysik et al., is directed towards a lotion formula that can be applied to a tissue, which transfers the lotion to the user's skin in order to reduce irritation and redness. U.S. Pat. No. 5,871,763 to Luu et al., as well is directed towards a lotion formula that is applied to a substrate for skin care treatment. The lotion composition of '763 is melted by the heat produced by the hands of a user of the cellulosic substrate to enable the lotion's transfer to the user's skin. Another lotion-treated substrate is described in U.S. Pat. No. 5,525,345 to Warner et al. The lotion composition of '345 comprises a plastic or fluid emollient that is solid or semi solid at room temperature and an immobilizing agent with a melting point above room temperature, which stabilizes the lotion composition on the surface of the substrate. See also U.S. application Ser. No. 10/483,633 (Publication No. US 2005/0031847), where two separate and distinct phases, lipid and aqueous, are applied to a substrate to facilitate cleansing of skin. Further, there is described in U.S. Pat. No. 4,987,632 to Rowe et al., a cleaning wipe treated with a composition containing detergent, which is leached out upon contact with water.

There are also known lotions containing anti-microbial and pH balancing agents to protect the skin. For example, U.S. Pat. No. 6,238,682 to Klofta et al. is directed towards a tissue treated with anhydrous skin lotion containing antimicrobial components in addition to hydrophilic solvents and surfactants. See also U.S. Pat. No. 6,352,700 to Luu et al., which is directed towards a substrate treated with a lotion that contains a skin pH balancing compound for maintaining a proper skin acid mantle. Other lotions containing antimicrobial agents include U.S. patent application Ser. No. 10/608,661 (Publication No. US 2004/0039353), which is directed towards wet wipes containing a Yucca species extract as an antimicrobial agent; U.S. patent application Ser. No. 09/851,273 (Publication No. US 2002/0031486), which is directed towards an antimicrobial cleansing composition, containing little or no volatile alcohol, that may be used alone or in combination with lotions and a like; U.S. Pat. No. 6,436,885 to Biedermann et al., which is directed towards an antimicrobial cleansing compositions that has a pH of from about 2 to about 5.5.; U.S. Pat. No. 6,383,505 to Kaiser et al. which is directed towards an antimicrobial lotion for topical use in a form of oil-in-water emulsion; additionally, similar subject matter is disclosed in U.S. Pat. No. 6,482,423 to Beerse et al.; U.S. Pat. No. 6,488,943 to Beerse et al.; U.S. Pat. No. 6,284,259 to Beerse et al.; U.S. Pat. No. 6,258,368 to Beerse et al.; U.S. Pat. No. 6,183,763 to Beerse et al.; and U.S. Pat. No. 6,210,695 to Beerse et al., as well.

Despite plentiful art, there exists a need for simple and effective means for promoting hygiene and skin care concurrently in connection with hand washing.

### SUMMARY OF THE INVENTION

A salient aspect of the invention involves application of a suitable anti-microbial lotion to a substrate in amounts that will actually increase WAR times of the cellulosic sheet. This feature, while usually undesirable in a towel product, promotes anti-microbial lotion transfer to the skin, since a user will rub the towel longer when drying his or her hands. Lotion transfer is extremely important for both skin care and anti-microbial effectiveness as will be appreciated by one of the skill in the art.

There is provided in one aspect of the invention an anti-microbial cellulosic sheet for paper towel including: a) a cellulosic web; b) a transferable lotion composition comprising an emollient and anti-microbial agent, the lotion composition being immobilized on the cellulosic web in a solid or semi-solid form, wherein the transferable lotion composition is selected from lotion compositions which are transferable upon contact with water or lotion compositions which are transferable upon application of heat; and c) the transferable lotion composition disposed on the web is selected and applied in amounts such that it imparts a water absorption rate delay of at least about 25% to the cellulosic web. In preferred embodiments, the transferable lotion composition disposed on the web is selected and applied in amounts such that it imparts a water absorption rate delay to the cellulosic web of at least about 50%, 75%, 100%, or more. So also, the unlotioned cellulosic web preferably has substantially the same SAT value as the lotioned cellulosic web. The cellulosic sheet may have SAT values of at least about 3 g/g, at least about 3.5 g/g, at least about 4 g/g or at least about 4.5 g/g. Typically, the cellulosic sheet has a SAT value of from about 3 g/g to about 5 g/g.

The lotioned cellulosic sheet typically has a WAR value of at least about 40 or 50 seconds, with WAR values of from about 55 seconds to about 75 seconds being generally suitable.

The transferable lotion is suitably applied to the cellulosic web in an amount of from about 3 weight percent to about 20 weight percent such as in an amount of from about 5 percent by weight to about 15 percent by weight or in an amount of from about 8 percent by weight to about 10 percent by weight (based on the combined weight of towel and lotion). The unlotioned cellulosic web may have a basis weight of from about 15 g/m² to about 65 g/m² such as from about 25 g/m² to about 50 g/m². A basis weight of from about 30 g/m² to about 40 g/m² is typical and the cellulosic web consists predominantly of softwood fiber. The web may include at least about 65 or 70 percent by weight softwood fiber and typically from about 70 percent by weight softwood fiber to about 90 percent by weight softwood fiber. A preferred softwood fiber is Douglas fir fiber especially for electronic (motion sensored) dispensers. The sheet suitably has an eight sheet caliper of from about 35 to about 90 mils, consists predominantly of softwood fiber and is in the form of a single ply towel.

Typically, the lotion composition comprises from about 0.01% to about 10% by weight anti-microbial agent; preferably from about 0.05% to about 5% by weight anti-microbial agent. The anti-microbial agent may be selected from: 2,4,4′-trichloro-2′-hydroxydiphenyl ether; 3,4,4′-trichlorocarbanilide; 3,4,4′-trifluoromethyl-4,4′-d- ichlorocarbanilide; 5-chloro-2-methyl-4-isothiazolin-3-one; iodopropynlbutylcarbamate; 8-hydroxyquinoline; 8-hydroxyquinoline citrate; 8-hydroxyquinoline sulfate; 4-chloro-3,5-xylenol; 2-bromo-2-nitropropane-1,3-diol; diazolidinyl urea; butoconazole; nystatin; terconazole; nitrofurantoin; phenazopyridine; acyclovir; clortrimazole; chloroxylenol; chlorhexidine; chlorhexidine gluconate; miconazole; terconazole; butylparaben; ethylparaben; methylparaben; methylchloroisothiazoline; methylisothiazoline; a mixture of 1,3-bis(hydroxymethyl)-5,5-dimethylhydantoin and 3-iodo-2-propynyl butyl carbamate; oxyquinoline; EDTA; tetrasodium EDTA; p-hydroxylbenzoic acid ester; alkyl pyridinum compounds; coco phosphatidyl PG-dimonium chloride; chlorhexidene digluconate; chlorhexidene acetate; chlorhexidene isethionate; chlorhexidene hydrochloride; benzalkonium chloride; benzethonium chloride; polyhexamethylene biguanide, zinc salts and mixtures thereof.

The web optionally includes a wet strength agent selected from aldehyde-containing polyols, aldehyde-containing cationic starch, glyoxal, glutaraldehyde, dialdehydes, boric acid carbonate, zirconium ammonium carbonate, glyoxalated polyacrylamide, polyamide-epichlorohydrin, polyamine-epichlorohydrin, urea-formaldehyde, melamine-formaldehyde, polyethyleneimine, and latex emulsions.

One preferred embodiment is an anti-microbial cellulosic sheet for paper towel including: a) a cellulosic towel web; b) a lotion emulsion including an anti-microbial agent disposed on the web, the lotion emulsion including a polar emollient and a non-polar emollient as well as a surfactant composition comprising a nonionic surfactant, wherein the lotion emulsion is substantially liquid at room temperature, the emollients and surfactant composition are selected such that the lotion emulsion is immobilized on the web in a semi-solid or solid state and wherein further the lotion emulsion is capable of forming an aqueous gel upon contact with water; and c) the lotion emulsion disposed on the web is selected and applied in amounts such that it imparts a water absorption rate delay of at least 25% to the cellulosic web. In connection with this class of lotioned sheet, the lotion emulsion typically comprises polar emollient in an amount of from about 2% to about 40% by weight of the lotion emulsion and the lotion emulsion may include a polar polyhydroxy emollient selected from propylene glycol, glycol, glycerol, diethylene glycol, methylene glycol, polypropylene glycol, polyethylene glycol and sorbitol. The lotion emulsion also preferably includes a non-polar emollient in the amount of from about 10% to about 40% by weight of the lotion emulsion, which non-polar emollient may be selected from aromatic or linear esters, Guerbet ester, mineral oil, squalane, liquid paraffin, and mixtures thereof. Suitable non-polar emollients thus include: isopropyl myristate; C₁₂-C₁₅ alkyl benzoate esters; tri-octyldodecyl-citrate; mixtures of C₁₂-C₁₅ alkyl benzoate esters; and carnation oil. The surfactant composition may include non-ionic surfactant including a fatty alcohol in the amount of from about 40% to about 70% by weight of the lotion emulsion. Suitable non-ionic surfactants may be selected from PEG-20 methyl glucose sesquistearate, PPG-20 methyl glucose ether, PPG-20 methyl glucose ether distearate, PEG-20 methyl glucose distearate, PEG-120 methyl glucose dioleate, ethoxylated methyl glucose having from about 10 to about 20 repeating ethoxy units, a mixture thereof and the like. The surfactant composition most preferably includes a co-surfactant in an amount of from about 0.1% to about 20% by weight of the lotion emulsion. The co-surfactant is suitably selected from C₁₂-C₁₈ fatty alcohols, behenyl alcohol, cetyl alcohol, stearyl alcohol, iso-cetyl alcohol, and iso-stearyl alcohol, myristyl alcohol, and mixtures of cetyl alcohol (C₁₆) and stearyl alcohol (C₁₈). Typically, the lotion emulsion is substantially waterless.

Another preferred embodiment is an anti-microbial cellulosic sheet comprising: a) a cellulosic web; b) a waterless micro-emulsion which is substantially liquid at room temperature immobilized on the web in a semi-solid or solid state; wherein the waterless micro-emulsion comprises an anti-microbial agent, a polar emollient, a non-polar emollient and a surfactant composition including a nonionic surfactant; and wherein further the waterless micro-emulsion is capable of forming an aqueous micro-emulsion upon contact with water; and c) the waterless micro-emulsion disposed on the web is selected and applied in amounts such that it imparts a water absorption rate delay of at least 25% to the cellulosic web.

Still another aspect of the invention is an anti-microbial cellulosic sheet for paper towel comprising: a) a cellulosic web; b) a transferable lotion composition disposed on the web comprising an emollient, an anti-microbial agent, and a retention/release agent such that the lotion has a ΔH above about 37° C. of more than about 10 calories/gram, a total heat of melting of above about 25 calories/gram, and an onset of melting temperature of at least about 30° C.; and c) the transferable lotion composition disposed on the web is selected and applied in amounts such that it imparts a water absorption rate delay of at least about 25% to the cellulosic web. The lotion composition on this sheet optionally further comprises a surfactant composition in the amount of from about 10% to about 15% by weight of the lotion composition. The surfactants may be selected from methyl glucoside sesquistearate, ethoxylated methyl glucoside sesquistearate containing 20 moles of oxyethylene units, mixtures of PEG-20 methyl glucose sesquistearate and methyl glucose sesquistearate, or combinations of the foregoing. Suitably the lotion composition comprises an emollient in the amount of from about 5% to about 75% by weight of the lotion composition. The emollient may be an aromatic ester emollient, a fatty alcohol ester of a non-fatty organic acid emollient, or mixtures thereof. Typical aromatic ester emollients may be benzoate ester emollients selected from C₁₂-C₁₅ alkyl benzoate, stearyl benzoate, octyl dodecyl benzoate, isostearyl benzoate, methyl gluceth-20 benzoate, stearyl ether benzoate, poloxamer 182 dibenzoate, poloxamer 105 benzoate, or mixtures thereof. A suitable fatty alcohol ester of a non-fatty organic acid emollient comprises C₁₂-C₁₅ octanoate.

The heat-sensitive lotion composition typically includes a retention/release agent in the amount of from about 25% to about 95% by weight of the lotion composition, wherein the retention/release agent may be a C₁₂-C₁₈ fatty alcohol. Suitable fatty alcohols are selected from dodecanol, tridecanol, tetradecanol, pentadecanol, hexadecanol, heptadecanol, octadecanol, mixtures of cetyl alcohol and stearyl alcohol and combinations of the foregoing.

Further aspects of the invention will become apparent from the discussion which follows.

### BRIEF DESCRIPTION OF THE DRAWINGS

FIG. 1 is a partial phase diagram of the composition of Example 1 showing the phase characteristics of a waterless micro-emulsion; and

FIG. 2 is a partial phase diagram of the composition of Example 1 with water showing the phase behavior of a mixture of the composition of Example 1 with water.

### DETAILED DESCRIPTION

The invention is described in detail below for purposes of illustration only. Modifications within the spirit and scope of the invention, set forth in the appended claims, will be readily apparent to one of skill in the art. As used herein, terminology and abbreviations have their ordinary meaning; for example, “cps” refers to centipoises; g refers to grams, mg refers to milligrams, m² refers to square meters and so forth.

Absorbency of the inventive products is measured with a simple absorbency tester. The simple absorbency tester is a particularly useful apparatus for measuring the hydrophilicity and absorbency properties of a sample of tissue, napkins, or towel. In this test a sample of tissue, napkins, or towel 2.0 inches in diameter is mounted between a top flat plastic cover and a bottom grooved sample plate. The tissue, napkin, or towel sample disc is held in place by a ⅛ inch wide circumference flange area. The sample is not compressed by the holder. De-ionized water at 73° F. is introduced to the sample at the center of the bottom sample plate through a 1 mm. diameter conduit. This water is at a hydrostatic head of minus 5 mm. Flow is initiated by a pulse introduced at the start of the measurement by the instrument mechanism. Water is thus imbibed by the tissue, napkin, or towel sample from this central entrance point radially outward by capillary action. When the rate of water imbibation decreases below 0.005 gm water per 5 seconds, the test is terminated. The amount of water removed from the reservoir and absorbed by the sample is weighed and reported as grams of water per square meter of sample or grams of water per gram of sheet. In practice, an M/K Systems Inc. Gravimetric Absorbency Testing System is used. This is a commercial system obtainable from M/K Systems Inc., 12 Garden Street, Danvers, Mass., 01923. WAC or water absorbent capacity also referred to as SAT is actually determined by the instrument itself. WAC is defined as the point where the weight versus time graph has a “zero” slope, i.e., the sample has stopped absorbing. The termination criteria for a test are expressed in maximum change in water weight absorbed over a fixed time period. This is basically an estimate of zero slope on the weight versus time graph. The program uses a change of 0.005 g over a 5 second time interval as termination criteria; unless “Slow SAT” is specified in which case the cut off criteria is 1 mg in 20 seconds.

Water absorbency rate or WAR, is measured in seconds and is the time it takes for a sample to absorb a 0.1 gram droplet of water disposed on its surface by way of an automated syringe. The test specimens are preferably conditioned at 23° C.±1° C. (73.4±1.8° F.) at 50% relative humidity. For each sample, 4 3×3 inch test specimens are prepared. Each specimen is placed in a sample holder such that a high intensity lamp is directed toward the specimen. 0.1 ml of water is deposited on the specimen surface and a stop watch is started. When the water is absorbed, as indicated by lack of further reflection of light from the drop, the stopwatch is stopped and the time recorded to the nearest 0.1 seconds. The procedure is repeated for each specimen and the results averaged for the sample. WAR is measured in accordance with TAPPI method T-432 om-99.

The water absorption rate delay in percent is calculated from the WAR values of the unlotioned cellulosic web and lotioned sheet product of the invention as follows:

Absorption rate delay=

(WAR value of lotioned cellulosic sheet−WAR value of unlotioned cellulosic web)÷(WAR value of unlotioned cellulosic web)×100%

“Aqueous gel” refers to viscous lotion/water compositions typically having a room temperature viscosity of above about 500 cps at room temperature and typically above about 1000 cps at room temperature. Preferred lotion compositions form gels of more than 1500 cps at room temperature as is seen in Table 2 below.

“Basis weight”, BWT, bwt and so forth is expressed in grams per square meter or pounds per 3000 square foot ream of product as is indicated.

The term “cellulosic”, “cellulosic sheet” and the like is meant to include any product incorporating papermaking fiber having cellulose as a major constituent. “Papermaking fibers” include virgin pulps or recycle (secondary) cellulosic fibers or fiber mixes comprising cellulosic fibers. Fibers suitable for making the webs of this invention include fibers such as those obtained from deciduous and coniferous trees, including softwood fibers, such as northern and southern softwood kraft fibers; hardwood fibers, such as eucalyptus, maple, birch, aspen, or the like as well as nonwood cellulosic fibers. Papermaking fibers can be liberated from their source material by any one of a number of chemical pulping processes familiar to one experienced in the art including sulfate, sulfite, polysulfide, soda pulping, etc. The pulp can be bleached if desired by chemical means including the use of chlorine, chlorine dioxide, oxygen, alkaline peroxide and so forth. The products of the present invention may comprise a blend of conventional fibers (whether derived from virgin pulp or recycle sources) and high coarseness lignin-rich tubular fibers, such as bleached chemical thermomechanical pulp (BCTMP). “Furnishes” and like terminology refers to aqueous compositions including papermaking fibers, optionally wet strength resins, debonders and the like for making paper products.

Preferably, the fiber in the towel products of the invention consists predominantly (more than 50% by weight of fiber based on fiber content) of softwood (SW) fiber such as Douglas fir. Southern Softwood Kraft (SSWK) is also a preferred fiber. Softwood fibers provide strength to the product; Southern softwoods are generally preferred for towel of the invention; however thin and flexible Northern softwood may be used in some fiber mixtures.

Percent means weight percent unless otherwise indicated and refers to weight percent without water unless the inclusion of the water weight is expressly indicated. Weight percent softwood fiber and like terminology or expressions refer to the weight percent of softwood fiber based on fiber content of a product or composition only, exclusive of other ingredients.

Room temperature is refers to a temperature of from about 20° C. to about 25° C.

Dry tensile strengths (MD and CD), stretch, ratios thereof, modulus, break modulus, stress and strain are measured with a standard Instron test device or other suitable elongation tensile tester which may be configured in various ways, typically using 3 or 1 inch wide strips of tissue or towel, conditioned in an atmosphere of 23°±1° C. (73.4°±1° F.) at 50% relative humidity for 2 hours. The tensile test is run at a crosshead speed of 2 in/min. Break modulus is expressed in grams/3 inches/% strain. % strain is dimensionless and need not be specified.

Tensile ratios are simply ratios of the values determined by way of the foregoing methods. Unless otherwise specified, a tensile property is a dry sheet property.

The wet tensile of the tissue of the present invention is measured using a three-inch wide strip of tissue that is folded into a loop, clamped in a special fixture termed a Finch Cup, then immersed in a water. The Finch Cup, which is available from the Thwing-Albert Instrument Company of Philadelphia, Pa., is mounted onto a tensile tester equipped with a 2.0 pound load cell with the flange of the Finch Cup clamped by the tester's lower jaw and the ends of tissue loop clamped into the upper jaw of the tensile tester. The sample is immersed in water that has been adjusted to a pH of 7.0+−0.1 and the tensile is tested after a 5 second immersion time.

“Waterless”, “substantially waterless” and like terminology refers to compositions which include generally less than about 10% by weight water. In cases where water is present at all, water is preferably not added as such, but is contained in other ingredients.

In some preferred embodiments of the present invention, the lotion composition is a “cold” lotion such as the lotions described in U.S. application Ser. No. 10/141,442 (United States Publication No. 2003/0211124) filed on May 7, 2002 and incorporated herein by reference in its entirety. “Cold” lotions refer to lotions that are substantially liquid at room temperature and can be applied as such to substrates. Due to the liquid state of the “cold” lotions at room temperature, they do not require heating or melting equipment and can be applied to the substrates by several available technologies such as spraying, printing, coating, extrusion or other techniques.

The cold lotion used in the present invention contains a micro-emulsion composition containing predominantly an emollient composition and a surfactant composition. The small particle size of the micro-emulsion increases the surface area of its constituents so it contributes to the utility of the present composition in increasing the interaction between the emollient and the skin surface; a desirable property for restoring the oil layer of the skin. Preferably, the micro-emulsion composition contains an external continuous non-polar or polar emollient, an internal discontinuous polar or non-polar emollient, a surfactant and a mixture of fatty alcohol co-surfactants. The lotion composition may also contain optional ingredients, including typical cosmetic additives, preservatives, plant extracts, fragrances, and medicinal agents. Any suitable combination or proportion of ingredients which produces a micro-emulsion can be used.

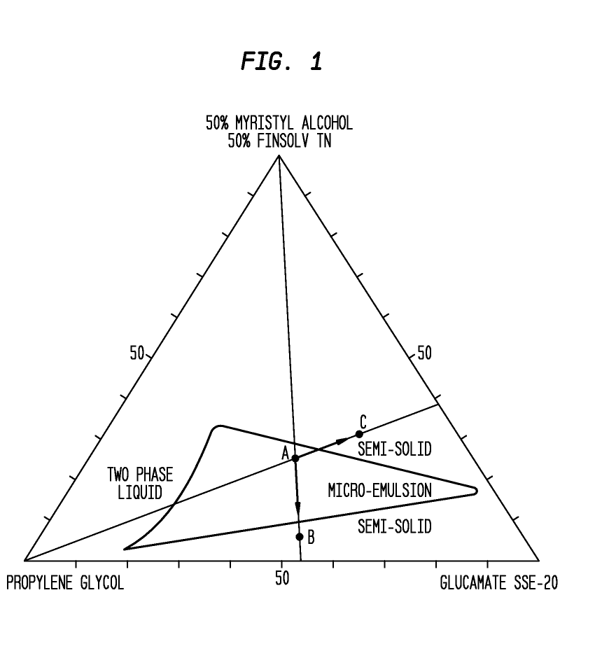

An important aspect of the cold lotion employed is when the liquid lotion contacts the fibers or non-woven substrate, it undergoes an in-situ phase change from liquid to immobilized semi-solid or solid form. This phase change of the lotion results when the substrate web surface fibers absorb the continuous outer phase of the micro-emulsion, which may be a non-polar or polar-emollient. Subsequently, the percent of the outer phase of the micro-emulsion within the composition is reduced, resulting in increase in the percent of the internal phase of the micro-emulsion and shuft of the original lotion composition from point A (liquid micro-emulsion) to points B or C (semi-solid state), which are located outside of the micro emulsion region (see FIG. 1). The immobilized antimicrobial lotion is restorable to transferable form upon contact with water and is capable of forming an aqueous gel. The compositions of the present invention are preferably chosen to lie within the micro-emulsion region of a given formulation. All percentages, ratios, and proportions of the ingredients within the compositions of the present invention are determined by the micro-emulsion region of a ternary phase diagram of the polar emollient/non-polar emollient/co-surfactant/non-ionic surfactant formulations (PE/NPE/COS/NIS). Outside of the micro-emulsion region on the low percent side of the polar or non-polar emollients, a semi-solid or solid region is preferably present. A micro-emulsion is thermodynamically stable and is essentially transparent in the visible region of the spectrum, which typically indicates that particle size diameter is preferably less than about 0.1 micron, or so. When the particle size diameter is greater than about 3,200 A (about 0.32 micron), the liquid is no longer considered a micro-emulsion but is an emulsion which can often appear turbid and be thermodynamically unstable. The micelle structure of a micro-emulsion is either a “direct” type (head out/tail in) or an “inverse” type (head in/tail out). The liquid micro-emulsion increases the surface area of the lipophilic constituent so it contributes significantly to the utility of the present composition in neat form. Fluidity on the skin surface, small particle size, high surface area and high hydrophilic character, are highly desirable properties for cleansing purposes either when the substrate is used by itself or when lotioned products are rewet with water. Any combination or proportion of these ingredients which produces a micro-emulsion can be used.

A hot lotion composition used in connection with the present invention is chosen such that its ΔH of above about 37° C. is above about 10 calories/gram, ΔH of below about 37° C. is above about 15 calories/gram, ΔH total (total energy to melt) of above about 37° C. is above about 25 calories/gram. Further, the retention/release agent is preferably selected to have a melting point substantially higher than about room temperature but lower than about 65° C., such that the lotion onset of melting temperature is within the range of from about 30° C. to about 45° C. This enables the lotion composition to maintain a substantially solid state at about room temperature and partially melted state at human skin temperature.

It should be noted that for purposes of this description, the temperature of human skin is between about 30° C. to about 37° C. and room temperature is between about 20° C. to about 25° C.

An important aspect of a hot lotion used is that it is partially melted by body heat to enable transfer to the skin of partially liquefied and partially solid emollient(s), particles of retention/release agent and other ingredients. The partial melting of the lotion is important, because when the lotion is completely melted to liquid by body heat it is perceived as too greasy, and when a lotion is not sufficiently melted by body heat, it would not spread easily on the skin. At least a portion of the partially melted lotion resolidifies on the skin to form a smooth and moisturizing layer. Further details as to suitable hot lotion compositions are found in U.S. Pat. No. 5,871,763, the disclosure of which is incorporated herein in its entirety.

Optionally included in the anti-microbial lotions are suitable anti-viral agents including those effective against, or at least retardant toward Corona virus, Picorna virus, Rhino virus, Herpes simplex, Herpes genitalis, Herpes labialis, Respiratory Syncytial Virus (RSV), Para influenza, Cytomegalovirus, Adenovirus, Condyloma and certain synergistic disease states that can involve a virus and a protozoa or a virus and any unfriendly enzymes, e.g., protease, lipase and amylase, that cause a compromised skin as a precursor state for a viral infection to occur. Specific anti-viral agents suitable for use in the lotions include bioflavonoids such as hesperitin, naringin, catechin and certain selected amino acids of leguminous origin such as L-canavanine and an analog of L-arginine; dicarboxylic acids such as malonic, glutaric, citric, succinic, and diglycolic acids; alpha hydroxy carboxylic acid such as D-galacturonic acid from Sterculia urens; neem seed oil (Azadirachta indica) in its un-denatured form; sandalwood oil (Santalum album L.) in its un-denatured form. Optionally, the anti-viral agent could be admixed with at most about 50% by weight of the anti-viral agent of a protease inhibitor such as zinc oxide or other suitable zinc salt.

The cold or hot lotion composition can include other optional components typically present in lotions of this type. These optional components include a botanical extract, such as aloe extract, avocado oil, basil extract, sesame oil, olive oil, jojoba oil, chamomile extract, eucalyptus extract, peppermint extract, as well as animal oils such as emu oil, cod liver oil, orange roughy oil, mink oil, and the like.

The lotion of the present invention can also optionally include a humectant. Humectants are hygroscopic materials with a two-fold moisturizing action including water retention and water absorption. Humectants prevent the loss of moisture from skin and help to attract moisture from the environment. Preferred humectants include glycerol, hydrolyzed silk, ammonium lactate, hydroxypropyltrimonium hydrolyzed silk, hydroxypropyl chitosan, hydroxypropyltrimonium hydrolyzed wheat protein, lactamidopropyltrimonium chloride, and ethyl ester of hydrolyzed silk. The botanical extract, animal oil or humectant is preferably present in an amount of less than about 3% when used in the base formulation of the lotion. Further optional components include a skin refreshing agent such as encapsulated water in oil, eucalyptus oil, and menthol oil. All of these optional materials are well known in the art as additives for such formulations and can be employed in appropriate amounts in the lotion compositions of the present invention by those skilled in the art.

The lotion can optionally include a fragrance. The fragrance can be present in an amount of from 0.01% to about 2%. Suitable fragrance includes volatile aromatic esters, non-aromatic esters, aromatic aldehydes, non-aromatic aldehydes, aromatic alcohols, non-aromatic alcohols, heterocyclic aroma chemicals, and natural floral fragrances, such as blossom, carnation, gardenia, geranium, iris, hawthorne, hyacinth and jasmine.

The lotion can also optionally include natural or synthetic powder like talc, mica, boron nitride, silicone, or mixtures thereof.

The towel web of the present invention can be any suitable cellulosic substrate web, optionally wet-strengthened, and optionally including synthetic fibrous material such as melt-blown polyethylene, polypropylene, copolymers of polyethylene. The substrate also may be embossed.

Wet strength agents which may be added include temporary as well as permanent wet strength agents. Suitable wet strength agents include glyoxal; glutaraldehyde; uncharged chemical moieties selected from a group consisting of dialdehydes, aldehyde-containing polyols, uncharged aldehyde-containing polymers, and cyclic ureas and mixtures thereof, and aldehyde-containing cationic starch; mixtures of polyvinyl alcohol and salts of multivalent anions, such as boric acid or zirconium ammonium carbonates; glyoxalated polyacrylamide; polyamide-epichlorohydrin; polyamine-epichlorohydrin; urea-formaldehyde; melamine-formaldehyde; polyethyleneimine; and latex emulsions.

The present invention includes a web of cellulosic fibers treated on at least one side thereof, preferably in an amount of from about 0.1% to about 25%, more preferably from about 0.5% to about 20%, by weight of the dried fiber web with an anti-microbial lotion.

The cellulosic substrate can be prepared according to conventional processes (including TAD, CWP and variants thereof) known to those skilled in the art. A preferred towel web is a fabric-creped towel web as is used in Example 18. Lotion can be applied to the substrate according to conventional application methods known to those skilled in the art.

### EXAMPLES 1-7

Formulations of the waterless lotion were prepared in which, the components, their ratios and the conditions selected to provide micro-emulsion subject to in-situ phase change upon contact with a cellulosic substrate were varied as shown in the following Examples.

In preparing each formulation the following, a general procedure was used. The polar phase propylene glycol was mixed with surfactant and co-surfactant in a heated container at about 60° C. to about 70° C. until the chemicals were completely melted. The non-polar oil phase was added to the mixture with moderate agitation for about 10 minutes, then cooled to room temperature. At this point the lotion was in clear liquid form and ready to apply to the substrate. The micro-emulsion formed spontaneously without the need for a high shear mechanical device and is stable indefinitely.

Examples 1 to 7 were prepared in accordance with U.S. patent application Ser. No. 10/141,442, the disclosure of which is incorporated herein by reference. These lotion formulas were liquid at room temperature, transparent, very stable and accordingly the lotion ingredient ratios were inside the micro-emulsion region of phase diagrams such as FIG. 1 which is a partial phase diagram of the composition of Example 1. Surprisingly, the lotion of the present invention is characterized as having a good hand-feel perception and non-greasy hand-feel, which is thought to be due to the particle size of the micro-emulsion being too small to be detected in the oil phase by the fingertips.

TABLE 1

| | Ex. 1 | Ex. 2 | Ex. 3 | Ex. 4 | Ex. 5 | Ex. 6 | Ex. 7 |
|---|---|---|---|---|---|---|---|
| Ingredients | (%) | (%) | (%) | (%) | (%) | (%) | (%) |
| Propylene glycol | 35 | 35 | 5 | 15 | 15 | 30 | 35 |
| Finsolv TN⁽¹⁾ | 12.5 | 0 | 16 | 0 | 30 | 15 | 0 |
| Carnation oil⁽²⁾ | 0 | 0 | 0 | 0 | 0 | 0 | 12.5 |
| Isopropyl myristate | 0 | 15 | 0 | 30 | 0 | 0 | 0 |
| Lambert CE 2000⁽³⁾ | 0 | 0 | 4 | 0 | 0 | 0 | 0 |
| Myristyl alcohol (C₁₄) | 12.5 | 15 | 0 | 0 | 0 | 0 | 12.5 |
| Kalcol 1618⁽⁴⁾ | 0 | 0 | 7.5 | 0 | 5.5 | 5.5 | 0 |
| Glucam P-20 | 0 | 0 | 67.5 | 0 | 49.5 | 49.5 | 0 |
| Distearate⁽⁵⁾ | | | | | | | |
| Glucamate SSE-20⁽⁶⁾ | 40 | 35 | 0 | 55 | 0 | 0 | 40 |

⁽¹⁾Finsolv TN: C₁₂–C₁₅ alkyl benzoate ester from Finetex Inc.
⁽²⁾Carnation: Mineral oil from Witco Corp.
⁽³⁾Lambert CT 2000 - tri-octyldodecyl-citrate (Guerbet ester) from Lambert Technologies.
⁽⁴⁾Kalcol 1618: Mixture 50/50 of cetyl alcohol (C16) and stearyl alcohol (C18) from Kao Corp.
⁽⁵⁾Glucan P-20 Distearate: PEG-20 methyl glucose distearate from Amer-chol.
⁽⁶⁾Glucamate SSE-20: PEG-20 methyl glucose sesquistearate from Amer-chol.

### EXAMPLE 8

The lotion prepared in Example 1 was applied to a tissue basesheet at a 5% add-on level, then converted to a two ply tissue product. The product was tested for the amount of lotion transferred to the skin. The results were compared with commercially available lotioned tissues by comparing the light reflection of cold lotion residual on glass relative to that from two other products. The scattering of light caused by lotion smeared onto the glass microscope slide was measured by using the UV/visible spectrophotometer in the wavelength region from 700 nm to 400 nm. Lotion was transferred to the slide by holding it between two layers of lotioned tissue for 30 seconds and then rubbing the tissue over the slide 20 times in 15 seconds. The lotion smeared glass slide was placed in the sample beam of a double beam UV/Visible spectrometer to measure the light scattering. The results show that scattering of light caused by lotion smeared onto the slide rubbed with the tissue treated with the lotion in Example 1, looked identical to the control (untreated tissue). However, the two commercially available lotioned facial tissue products tested produced a significant amount of light scattering compared to the lotioned tissue of the present invention. In fact, the containers for these commercial products specifically state “not recommended for cleaning eyeglasses.” In addition, from the lab test result, the amount of lotion transferred by the lotioned substrate of the present invention to the skin was measured to be about 4.2 mg/cm².

The lotioned substrate product of the present invention was able to transfer lotion to the skin for enhancing skin care benefits, while also being able to “wipe eyeglasses and still maintain clear vision.” These properties of the present invention represent significant advantages over the lotioned facial tissues of the prior art.

The waterless emulsion compositions of the present invention have numerous attributes which make them particularly suitable for paper towels. For one, the waterless micro-emulsions form low viscosity aqueous micro-emulsions with relatively small amounts of water such that an immobilized lotion on the substrate is restorable to readily transferable form when wetted or mixed with water. Thus, when contacted with wet hands of a paper towel user, for example, the lotion is readily transferred from the towel to the skin of a user.

Another unique characteristic of the invention is that the lotion emulsions are capable of forming viscous gels with water as the amount of water mixed with the lotion is increased. Gels are generally more glutinous than liquids, thus being more desirable as hand lotions.

Details as to these characteristics appear in Examples 9-16 below.

### EXAMPLES 9-16

The composition of Example 1 was mixed with water and tested for viscosity using a Brookfield Digital Viscometer at 73° F. Examples 9, 10, 11 and 16 were tested with a No. 2 spindle, while Examples, 12, 13, 14 and 15 were tested with a No. 5 spindle. Details as to composition and test conditions appear in Table 2 below.

TABLE 2
Aqueous Phasing Properties

| Example #/ | | Speed | Viscosity | Appearance and |
|---|---|---|---|---|
| Description | Spindle # | (RPM) | (cps) | Properties |
| 9/100% Lotion | 2 | 50 | 182 | Clear Liquid |
| Example #1 | | | | |
| 10/95% Lotion | 2 | 50 | 218 | Clear Liquid |
| Example #1 + 5% | | | | |
| Water | | | | |
| 11/90% Lotion | 2 | 50 | 348 | Clear Liquid |
| Example #1 + 10% | | | | |
| Water | | | | |
| 12/85% Lotion | 5 | 10 | 4,600 | Viscous gel |
| Example #1 + 15% | | | | |
| Water | | | | |
| 13/80% Lotion | 5 | 10 | 22,000 (2) | Elastic gel |
| Example #1 + 20% | | | | |
| Water | | | | |
| 14/70% Lotion | 5 | 10 | 13,000 | Crystalline gel |
| Example #1 + 30% | | | (2&3) | |
| Water | | | | |
| 15/50% Lotion | 5 | 10 | 3,500 | Viscous turbid |
| Example #1 + 50% | | | | gel |
| Water | | | | |
| 16/20% Lotion | 2 | 50 | 140 | Turbid |
| Example #1 + 80% | | | | emulsion |
| Water | | | | |

It is seen in Table 2 that the water/emulsion mixtures remained a micro-emulsion up to a water concentration of between 10% and 15% by weight of the composition (Examples 9-12). At 15% water, the lotion emulsion turned into a viscous gel, which became even more viscous as additional water was added. At 20% water, the composition was an elastic gel having a viscosity of 22,000 cps, making viscosity measurement difficult. At 30% water (Example 14), the gel exhibited some opacity and appeared to have some crystalline structure appearing almost brittle. Due to the difficulty of viscosity measurement as well as the elastic and adhesive properties of the elastic gel of Example 13, the actual difference in viscosity between Examples 13, 14 may be less than indicated in Table 2.

At 50% by weight water, viscosity fell off dramatically and the composition appeared to be a viscous, turbid gel which was somewhat translucent. While the viscosities of Examples 12 and 15 were similar, the composition of Example 14 exhibited considerably more turbidity. At 80% water, viscosity was low again; however, the composition was no longer clear and appeared to be an emulsion which was somewhat turbid.

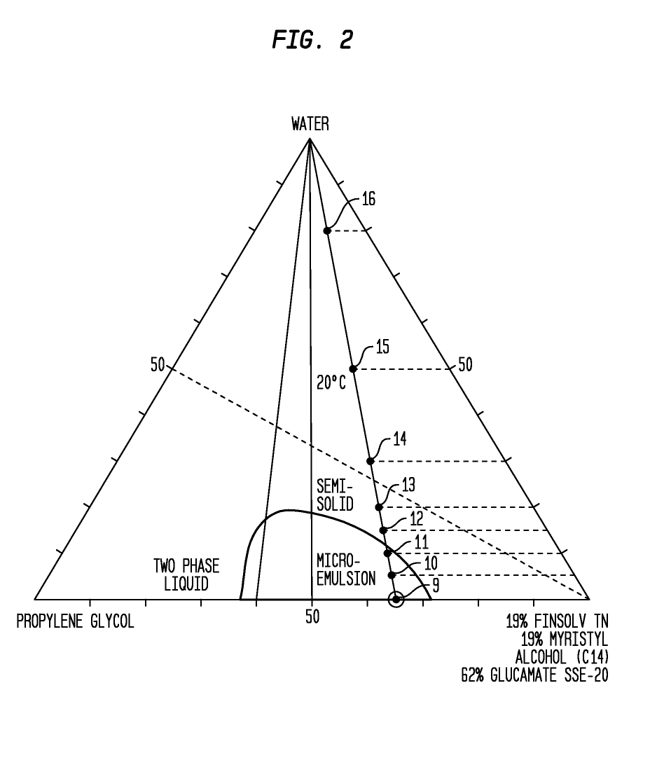

The phase behaviors of the mixtures of Table 2 are illustrated in the partial phase diagram of FIG. 2, where it is seen that Examples 9, 10 and 11 are within the micro-emulsion region of the phase diagram. Examples 12, 13, 14 and 15 are in “semi solid” form, while Example 16 is a two-phase liquid.

### EXAMPLE 17 AND COMPARATIVE EXAMPLE A

Still further features of the invention which are highly desirable include WAR delay which promotes lotion transfer to the skin and anti-microbial action of paper towel. These features are appreciated form the discussion which follows.

Towel basesheet was prepared using 100% Douglas Fir Kraft fiber by way of a fabric crepe/Yankee dry process of the class disclosed in co-pending U.S. patent application Ser. No. 11/451,111, entitled “Fabric-Creped Sheet for Dispensers”, filed Jun. 12, 2006 (Attorney Docket No. 20079; GP-05-10), the relevant disclosure of which is incorporated herein by reference in its entirety. To the basesheet, lotion was applied in 1″ bands along the machine direction (alternating with 1″ bands of unlotioned towel) using a Dynatec™ applicator of the class seen in U.S. Pat. Nos. 5,904,298; 5,902,540; and 5,882,573, the disclosures of which are incorporated herein by reference. The lotion formulation of Example 1 was used, containing additionally 2% by weight lotion triclosan anti-microbial compound, 2, 4,4′-trichloro-2′-hydroxy diphenyl ether. Further details appear in Table 3 below.

The towel was treated for anti-microbial properties by placing a wetted specimen disk of towel in a Petri dish on inoculated agar. The anti-microbial properties are termed “negative” if microbe contamination is observed on or at the towel after incubation and “positive” if a “ring” around the test specimen is observed, indicating that microbe growth was inhibited by the towel.

Results of anti-microbial testing also appear in Table 3.

TABLE 3
Anti-microbial and Towel Properties

| | Example A | Example 17 |
|---|---|---|
| Properties | No Lotion | Lotioned |
| Anti-microbial Properties: | | |
| Staphylococcus aureus | Negative | Positive |
| E. coli | Negative | Positive |
| Salmonella sps | Negative | Positive |
| Physical Properties: | | |
| Add on rate (% of product weight) | 0% | 8 to 10% |
| Basis Weight (lbs/rm) | 22.2 | 23.5 |
| Caliper (mils/8 sheets) | 46.0 | 46.1 |
| Dry MD Tensile (g/3″) | 6531.2 | 5528.9 |
| Dry CD Tensile (g/3″) | 3912.0 | 3435.1 |
| MD Stretch (%) | 7.4 | 7.7 |
| CD Stretch (%) | 3.3 | 3.7 |
| Wet MD Cured Tensile (g/3″) | 1976.1 | 2040.1 |
| (Finch) | | |
| Wet CD Cured Tensile (g/3″) | 1041.0 | 1122.1 |
| (Finch) | | |
| WAR (seconds) (TAPPI) | 34.3 | 67.6 |
| MacBeth 3100 Brightness (%) | 77.5 | 75.5 |
| UV Excluded | | |
| Opacity (%) | 60.2 | 56.6 |
| SAT Capacity (g/m\hat{ }2) | 125.1 | 123.0 |
| SAT Time (seconds) | 643.7 | 823.6 |
| GM Break Modulus | 1025.2 | 829.0 |

It is seen in Table 3 that the anti-microbial lotion was effective against staphylococcus aureous, E. coli and salmonella sps.

It is also seen that, with the absorbent capacity (SAT) of the control and the lotioned towel remained substantially the same, WAR times, or absorption rates were considerably lengthened, perhaps due to gel blockage; consistent with the data in Table 2 above. Higher WAR values are generally not desired; however, the glutinous gel feel and initial “wetness” experienced by a towel user is a positive consequence, offsetting lower measured absorption rates and encouraging more wiping action so the anti-microbial lotion is more effective in preventing or ameliorating contamination. The apparent gel blockage also appeared to increase CD wet tensile, a common source of towel failure.

### EXAMPLES 18-22

The lotion compositions in the following examples comprise a base lotion with and without a pH balancing agent. Suitable pH balancing agents include glycolic acid, alpha-acetyl glycolic acid, lactic acid, tartaric acid, alpha-acetyl lactic acid, alpha-hydroxy isobutyric acid, salicylic acid, mandelic acid, ortho-acetyl mandelic acid, benzilic acid, ortho-acetyl benzilic acid, malic acid, citric acid, gluconic acid, pyruvic acid, sorbic acid and combinations thereof. Examples 18 and 19 are comparative and contain no pH balancing agent, and Examples 20-22 relate to lotions compositions combined with a pH balancing agent. Further detail is seen in U.S. Pat. No. 6,352,700, the disclosure of which is incorporated herein in its entirety.

The lotions in Examples 20-22 were prepared according to the following procedure: the base lotion ingredients, i.e., emollient(s), release and retention agent and surfactants were mixed together and heated to 75° C. until the mixture was completely melted. Note lotion composition components in Table 4. The lotion composition mixture was maintained at 75° C. for about 15 minutes with moderate agitation. The pH balancing compound was then added, using high agitation, until the compound was completely melted and blended. The pH value for each lotion was determined by emulsifying 0.276 g of solid lotion (equivalent to the lotion amount contained in 5 sheets of 15% lotionized tissue) in 20 ml tap water (pH=8.65) at 23° C. The emulsion was shaken for 5 minutes before measuring pH using a standard calibrated pH meter.

TABLE 4
pH Balanced Lotions

| | Example 18 | Example 19 | Example 20 | Example 21 | Example 22 |
|---|---|---|---|---|---|
| Chemicals | (%) | (%) | (%) | (%) | (%) |
| Finsolv | 30 | 35 | 35 | 30 | 30 |
| TN-C12–C15 alkyl | | | | | |
| benzoate | | | | | |
| Crodacol CS 50 | 57 | 65 | 63 | 56 | 55 |
| (Cetearyl alcohol) | | | | | |
| Glucate SS (methyl | 3 | 0 | 0 | 3 | 3 |
| glucose sesquistearate) | | | | | |
| Glucamate SSE-20 | 10 | 0 | 0 | 10 | 10 |
| (PEG-20 methyl glucose | | | | | |
| sesquistearate) | | | | | |
| Glycolic acid | 0 | 0 | 2 | 1 | 0 |
| Lactic acid | 0 | 0 | 0 | 0 | 2 |
| pH | 7.8 | 7.2 | 4.6 | 4.9 | 5.3 |

While the invention has been described in connection with numerous examples, modifications to those examples within the spirit and scope of the invention will be readily apparent to those of skill in the art. In view of the foregoing discussion, relevant knowledge in the art and references including co-pending applications discussed above, the relevant disclosures of which are all incorporated herein by reference, further description is deemed unnecessary.

What is claimed is:

1. An anti-microbial cellulosic sheet for paper towel comprising:
a) a cellulosic web;
b) a transferable lotion composition comprising an emollient and anti-microbial agent, the lotion composition being immobilized on the cellulosic web in a solid or semi-solid form,
wherein the transferable lotion composition is selected from lotion compositions which are transferable upon contact with water or lotion compositions which are transferable upon application of heat; and
c) the transferable lotion composition disposed on the web is selected and applied in amounts such that it imparts a water absorption rate delay of at least about 25% to the cellulosic web.

2. The anti-microbial cellulosic sheet according to claim 1, wherein the transferable lotion composition disposed on the web is selected and applied in amounts such that it imparts a water absorption rate delay to the cellulosic web of at least about 50%.

3. The anti-microbial cellulosic sheet according to claim 1, wherein the transferable lotion composition disposed on the web is selected and applied in amounts such that it imparts a water absorption delay to the cellulosic web of at least about 75%.

4. The anti-microbial cellulosic sheet according to claim 1, wherein the transferable lotion composition disposed on the web is selected and applied in amounts such that it imparts a water absorption delay to the cellulosic web of at least about 100%.

5. The anti-microbial cellulosic sheet according to claim 1, wherein the unlotioned cellulosic web has substantially the same SAT value as the lotioned cellulosic web.

6. The anti-microbial cellulosic sheet according to claim 1, wherein the cellulosic sheet has a SAT value of at least about 3 g/g.

7. The anti-microbial cellulosic sheet according to claim 1, wherein the cellulosic sheet has a SAT value of at least about 3.5 g/g.

8. The anti-microbial cellulosic sheet according to claim 1, wherein the cellulosic sheet has a SAT value of at least about 4 g/g.

9. The anti-microbial cellulosic sheet according to claim 1, wherein the cellulosic sheet has a SAT value of at least about 4.5 g/g.

10. The anti-microbial cellulosic sheet according to claim 1, wherein the cellulosic sheet has a SAT value of from about 3 g/g to about 5 g/g.

11. The anti-microbial cellulosic sheet according to claim 1, wherein the cellulosic sheet has a WAR value of at least about 40 seconds.

12. The anti-microbial cellulosic sheet according to claim 1, wherein the cellulosic sheet has a WAR value of at least about 50 seconds.

13. The anti-microbial cellulosic sheet according to claim 1, wherein the cellulosic sheet has a WAR value of from about 55 seconds to about 75 seconds.

14. The anti-microbial cellulosic sheet according to claim 1, wherein the transferable lotion is applied to the cellulosic web in an amount of from about 3 weight percent to about 20 weight percent.

15. The anti-microbial cellulosic sheet according to claim 1, wherein the transferable lotion is applied to the cellulosic web in an amount of from about 5 percent by weight to about 15 percent by weight.

16. The anti-microbial cellulosic sheet according to claim 1, wherein the transferable lotion is applied to the cellulosic web in an amount of from about 8 percent by weight to about 10 percent by weight.

17. The anti-microbial cellulosic sheet according to claim 1, wherein the unlotioned cellulosic web has a basis weight of from about 15 g/m² to about 65 g/m².

18. The anti-microbial cellulosic sheet according to claim 1, wherein the unlotioned cellulosic web has a basis weight of from about 25 g/m² to about 50 g/m².

19. The anti-microbial cellulosic sheet according to claim 1, wherein the unlotioned cellulosic web has a basis weight of from about 30 g/m² to about 40 g/m².

20. The anti-microbial cellulosic sheet according to claim 1, wherein the cellulosic web consists predominantly of softwood fiber.

21. The anti-microbial cellulosic sheet according to claim 1, wherein the cellulosic web comprises at least about 65 percent by weight softwood fiber.

22. The anti-microbial cellulosic sheet according to claim 1, wherein the cellulosic web comprises at least about 70 percent by weight softwood fiber.

23. The anti-microbial cellulosic sheet according to claim 1, wherein the cellulosic web comprises from about 70 percent by weight softwood fiber to about 90 percent by weight softwood fiber.

24. The anti-microbial cellulosic sheet according to claim 1, wherein the cellulosic web consists predominantly of Douglas fir fiber.

25. The anti-microbial cellulosic sheet according to claim 1, wherein the sheet has an eight sheet caliper of from about 35 to about 90 mils, consists predominantly of softwood fiber and is in the form of a single ply towel.

26. The anti-microbial cellulosic sheet according to claim 1, wherein the cellulosic web comprises at least about 70 percent by weight Douglas fir fiber.

27. The anti-microbial cellulosic sheet according to claim 1, wherein the lotion composition comprises from about 0.01% to about 10% by weight anti-microbial agent.

28. The anti-microbial cellulosic sheet according to claim 1, wherein the lotion composition comprises from about 0.05% to about 5% by weight anti-microbial agent.

29. The anti-microbial cellulosic sheet according to claim 1, comprising an anti-microbial agent selected from: 2,4,4′-trichloro-2′-hydroxydiphenyl ether; 3,4,4′-trichlorocarbanilide; 3,4,4′-trifluoromethyl-4,4′-d- ichlorocarbanilide; 5-chloro-2-methyl-4-isothiazolin-3-one; iodopropynlbutylcarbamate; 8-hydroxyquinoline; 8-hydroxyquinoline citrate; 8-hydroxyquinoline sulfate; 4-chloro-3,5-xylenol; 2-bromo-2-nitropropane-1,3-diol; diazolidinyl urea; butoconazole; nystatin; terconazole; nitrofurantoin; phenazopyridine; acyclovir; clortrimazole; chloroxylenol; chlorhexidine; chlorhexidine gluconate; miconazole; terconazole; butylparaben; ethylparaben; methylparaben; methylchloroisothiazoline; methylisothiazoline; a mixture of 1,3-bis(hydroxymethyl)-5,5-dimethylhydantoin and 3-iodo-2-propynyl butyl carbamate; oxyquinoline; EDTA; tetrasodium EDTA; p-hydroxylbenzoic acid ester; alkyl pyridinum compounds; coco phosphatidyl PG-dimonium chloride; chlorhexidene digluconate; chlorhexidene acetate; chlorhexidene isethionate; chlorhexidene hydrochloride; benzalkonium chloride; benzethonium chloride; polyhexamethylene biguanide, and mixtures thereof.

30. The anti-microbial cellulosic sheet according to claim 1, wherein the anti-microbial agent is 2,4,4′-trichloro-2′-hydroxydiphenyl ether.

31. The anti-microbial cellulosic sheet according to claim 1, wherein the anti-microbial agent comprises a benzalkonium chloride.

32. The anti-microbial cellulosic sheet according to claim 1, wherein the anti-microbial agent comprises a zinc salt.

33. The anti-microbial cellulosic sheet according to claim 1, wherein the cellulosic web is predominantly softwood fiber and the anti-microbial agent is selected from: 2,4,4′-trichloro-2′-hydroxydiphenyl ether; 3,4,4′-trichlorocarbanilide; 3,4,4′-trifluoromethyl-4,4′-d- ichlorocarbanilide; 5-chloro-2-methyl-4-isothiazolin-3-one; iodopropynlbutylcarbamate; 8-hydroxyquinoline; 8-hydroxyquinoline citrate; 8-hydroxyquinoline sulfate; 4-chloro-3,5-xylenol; 2-bromo-2-nitropropane-1,3-diol; diazolidinyl urea; butoconazole; nystatin; terconazole; nitrofurantoin; phenazopyridine; acyclovir; clortrimazole; chloroxylenol; chlorhexidine; chlorhexidine gluconate; miconazole; terconazole; butylparaben; ethylparaben; methylparaben; methylchloroisothiazoline; methylisothiazoline; a mixture of 1,3-bis(hydroxymethyl)-5,5-dimethylhydantoin and 3-iodo-2-propynyl butyl carbamate; oxyquinoline; EDTA; tetrasodium EDTA; p-hydroxylbenzoic acid ester; alkyl pyridinum compounds; coco phosphatidyl PG-dimonium chloride; chlorhexidene digluconate; chlorhexidene acetate; chlorhexidene isethionate; chlorhexidene hydrochloride; benzalkonium chloride; benzethonium chloride; polyhexamethylene biguanide, and mixtures thereof.

34. The anti-microbial cellulosic sheet according to claim 1, wherein the web comprises a wet strength agent.

35. The anti-microbial cellulosic sheet according to claim 34, wherein the wet strength agent is selected from aldehyde-containing polyols, aldehyde-containing cationic starch, glyoxal, glutaraldehyde, dialdehydes, boric acid carbonate, zirconium ammonium carbonate, glyoxalated polyacrylamide, polyamide-epichlorohydrin, polyamine-epichlorohydrin, urea-formaldehyde, melamine-formaldehyde, polyethyleneimine, and latex emulsions.

36. An anti-microbial cellulosic sheet for paper towel comprising:
a) a cellulosic web;
b) a lotion emulsion including an anti-microbial agent disposed on the web, the lotion emulsion including a polar emollient and a non-polar emollient as well as a surfactant composition comprising a nonionic surfactant, wherein the lotion emulsion is substantially liquid at room temperature, the emollients and surfactant composition are selected such that the lotion emulsion is immobilized on the web in a semi-solid or solid state and wherein further the lotion emulsion is capable of forming an aqueous gel upon contact with water; and
c) the lotion emulsion disposed on the web being selected and applied in amounts such that it imparts a water absorption rate delay of at least 25% to the cellulosic web.

37. The anti-microbial cellulosic sheet according to claim 36, wherein the lotion emulsion comprises polar emollient in an amount of from about 2% to about 40% by weight of the lotion emulsion.

38. The anti-microbial cellulosic sheet according to claim 36, wherein the lotion emulsion comprises a polar polyhydroxy emollient selected from propylene glycol, glycol, glycerol, diethylene glycol, methylene glycol, polypropylene glycol, polyethylene glycol and sorbitol.

39. The anti-microbial cellulosic sheet according to claim 38, wherein the polar emollient is propylene glycol.

40. The anti-microbial cellulosic sheet according to claim 36, wherein the lotion emulsion comprises non-polar emollient in the amount of from about 10% to about 40% by weight of the lotion emulsion.

41. The anti-microbial cellulosic sheet according to claim 36, wherein the lotion emulsion comprises a non-polar emollient selected from aromatic or linear esters, Guerbet ester, mineral oil, squalane, liquid paraffin, and mixtures thereof.

42. The anti-microbial cellulosic sheet according to claim 41, wherein the non-polar emollient is isopropyl myristate.

43. The anti-microbial cellulosic sheet according to claim 41, wherein the non-polar emollient is C₁₂-C₁₅ alkyl benzoate ester.

44. The anti-microbial cellulosic sheet according to claim 41, wherein the non-polar emollient is tri-octyldodecyl-citrate.

45. The anti-microbial cellulosic sheet according to claim 41, wherein the non-polar emollient is a mixture of C₁₂-C₁₅ alkyl benzoate ester and carnation oil.

46. The anti-microbial cellulosic sheet according to claim 36, wherein the surfactant composition comprises non-ionic surfactant including a fatty alcohol in the amount of from about 40% to about 70% by weight of the lotion emulsion.

47. The anti-microbial cellulosic sheet according to claim 36, wherein the surfactant composition comprises a non-ionic surfactant selected from PEG-20 methyl glucose sesquistearate, PPG-20 methyl glucose ether, PPG-20 methyl glucose ether distearate, PEG-20 methyl glucose distearate, PEG-120 methyl glucose dioleate, ethoxylated methyl glucose having from about 10 to about 20 repeating ethoxy units, and mixtures thereof.

48. The anti-microbial cellulosic sheet according to claim 47, wherein the non-ionic surfactant comprises PEG-20 methyl glucose sesquistearate.

49. The anti-microbial cellulosic sheet according to claim 47, wherein the non-ionic surfactant comprises PEG-20 methyl glucose distearate.

50. The anti-microbial cellulosic sheet according to claim 36, wherein the surfactant composition comprises a co-surfactant in the amount of from about 0.1% to about 20% by weight of the lotion emulsion.

51. The anti-microbial cellulosic sheet according to claim 50, wherein the surfactant composition comprises a co-surfactant selected from C₁₂-C₁₈ fatty alcohols, behenyl alcohol, cetyl alcohol, stearyl alcohol, iso-cetyl alcohol, and iso-stearyl alcohol.

52. The anti-microbial cellulosic sheet according to claim 50, wherein the co-surfactant is myristyl alcohol.

53. The anti-microbial cellulosic sheet according to claim 50, wherein the co-surfactant is a mixture of cetyl alcohol (C₁₆) and stearyl alcohol (C₁₈).

54. The anti-microbial cellulosic sheet according to claim 36, wherein the lotion emulsion is substantially waterless.

55. An anti-microbial cellulosic sheet comprising:
(a) a cellulosic web;
(b) a waterless micro-emulsion which is substantially liquid at room temperature immobilized on the web in a semi-solid or solid state;
(c) wherein the waterless micro-emulsion comprises an anti-microbial agent, a polar emollient, a non-polar emollient and a surfactant composition including a nonionic surfactant; and wherein further the waterless micro-emulsion is capable of forming an aqueous micro-emulsion upon contact with water; and
d) the waterless micro-emulsion disposed on the web is selected and applied in amounts such that it imparts a water absorption rate delay of at least 25% to the cellulosic web.

56. An anti-microbial cellulosic sheet comprising:
a) a cellulosic web;
b) a transferable lotion composition disposed on the web comprising an emollient, an anti-microbial agent, and a retention/release agent such that the lotion has a ΔH above about 37° C. of more than about 10 calories/gram, a total heat of melting of above about 25 calories/gram, and an onset of melting temperature of at least about 30° C.; and
c) the transferable lotion composition disposed on the web being selected and applied in amounts such that it imparts a water absorption rate delay of at least about 25% to the cellulosic web.

57. The anti-microbial cellullosic sheet according to claim 56, wherein the lotion composition further comprises a surfactant composition in the amount of from about 10% to about 15% by weight of the lotion composition.

58. The anti-microbial cellullosic sheet according to claim 56, wherein the lotion composition further comprises a surfactant selected from methyl glucoside sesquistearate, ethoxylated methyl glucoside sesquistearate containing 20 moles of oxyethylene units, or combinations thereof.

59. The anti-microbial cellullosic sheet according to claim 57, wherein the surfactant comprises a mixture of PEG-20 methyl glucose sesquistearate and methyl glucose sesquistearate.

60. The anti-microbial cellullosic sheet according to claim 56, wherein the lotion composition comprises an emollient in the amount of from about 5% to about 75% by weight of the lotion composition.

61. The anti-microbial cellullosic sheet according to claim 60, wherein the emollient comprises an aromatic ester emollient, a fatty alcohol ester of a non-fatty organic acid emollient, or mixtures thereof.

62. The anti-microbial cellullosic sheet according to claim 61, wherein the aromatic ester emollient is a benzoate ester emollient selected from C₁₂-C₁₅ alkyl benzoate, stearyl benzoate, octyl dodecyl benzoate, isostearyl benzoate, methyl gluceth-20 benzoate, stearyl ether benzoate, poloxamer 182 dibenzoate, poloxamer 105 benzoate, or mixtures thereof.

63. The anti-microbial cellullosic sheet according to claim 61, wherein the fatty alcohol ester of a non-fatty organic acid emollient comprises C₁₂-C₁₅ octanoate.

64. The anti-microbial cellullosic sheet according to claim 61, wherein the emollient is a mixture of C₁₂-C₁₅ alkyl benzoate.

65. The anti-microbial cellullosic sheet according to claim 56, wherein the lotion composition comprises a retention/release agent in the amount of from about 25% to about 95% by weight of the lotion composition.

66. The anti-microbial cellullosic sheet according to claim 56, wherein the retention/release agent comprises a C₁₂-C₁₈ fatty alcohol.

67. The anti-microbial cellullosic sheet according to claim 66, wherein the fatty alcohol is selected from dodecanol, tridecanol, tetradecanol, pentadecanol, hexadecanol, heptadecanol, octadecanol, or mixtures thereof.

68. The anti-microbial cellullosic sheet according to claim 66, wherein the fatty alcohol is a mixture of cetyl alcohol and stearyl alcohol.

69. The anti-microbial cellullosic sheet according to claim 56, wherein the lotion composition is substantially waterless.
